(19) United States
(12) Patent Application Publication
(10) Pub. No.: US 2023/0161398 A1
(43) Pub. Date: May 25, 2023

(54) DATA STORAGE SYSTEM WITH POWER CONSUMPTION EFFICIENCY AND METHODS OF OPERATING THE SAME

(71) Applicant: Rakuten Mobile, Inc., Tokyo (JP)

(72) Inventors: Rahul ATRI, Singapore (SG); Kazushige TAKEUCHI, Tokyo (JP); Mohit LUTHRA, Singapore (SG); Puneet DEVADIGA, Tokyo (JP); Shinya KITA, Tokyo (JP); Mihirraj Narendra DIXIT, Tokyo (JP); Surender Singh LAMBA, Tokyo (JP); Abhishek SHARMA, Tokyo (JP)

(21) Appl. No.: 17/455,921

(22) Filed: Nov. 22, 2021

(51) Int. Cl. G06F 1/3234; G06F 1/324; G06F 1/3293

(52) U.S. Cl. CPC G06F 1/3275; G06F 1/324; G06F 1/3293

(57) ABSTRACT

Included are methods and systems for controlling power consumption in a data storage system. In some embodiments, a method includes obtaining empirical power consumption data that indicates power consumption by the data storage system and obtaining empirical application event data that indicates an operational performance of the one or more software applications. The empirical power consumption data with the empirical application event data. The at least one processor frequency of the one or more processors in the data storage system is adjusted based on the correlating of the empirical power consumption data with the empirical application event data.

### BACKGROUND

Data storage systems often are large data centers with databases that store data for online accounts, online applications, and computer networks. Data storage systems are continuously looking up data and implementing software applications associated with that data. As such, these data storage systems consume enormous amounts of power. High power consumptions increases operating costs of data storage systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data storage system, in accordance with some embodiments.

FIG. 2 is a flow diagram of an exemplary method of controlling power consumption in a data storage system.

FIG. 3 is a table of a power consumption datum, in accordance with some embodiments.

FIG. 4 is a table of an application event datum, in accordance with some embodiments.

FIG. 5 is a time line of the generation of different power consumption datums and application event datums during a time period, in accordance with some embodiments.

FIG. 6 is a block diagram of data storage system having the server and the power control device along with software modules that are implemented by the server and the power control device in accordance with some embodiments.

FIG. 7 is a chart that indicates a relationship between power consumption parameters and computer frequency in accordance with some embodiments.

FIG. 8 is a block diagram of a data storage system having the server and the power control device along with software modules that are implemented by the server and the power control device in accordance with some embodiments.

FIG. 9 is a block diagram of a data storage system having the server and the power control device along with software modules that are implemented by the server and the power control device in accordance with some embodiments.

FIG. 10 is a block diagram of a data storage system having the server and the power control device along with software modules that are implemented by the server and the power control device in one example of a power consumption scheme.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

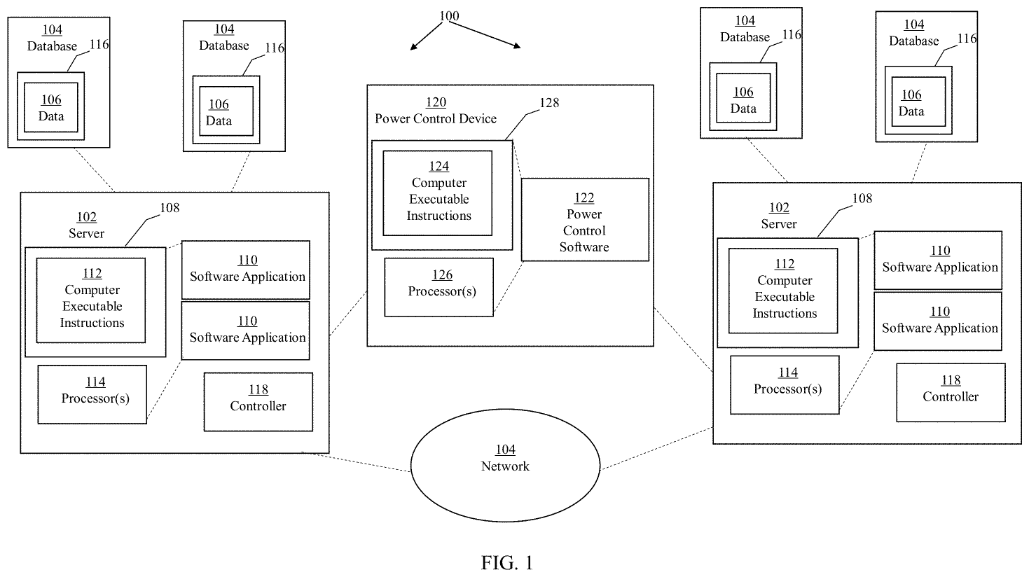

FIG. 1 is a block diagram of a data storage system 100, in accordance with some embodiments.

Data storage system 100 includes servers 102 that are operably connected to databases 104. Servers 102 are connected to a network 104 and are configured to manage the writing and storing of data 106 stored in non-transitory computer readable media 108 of the databases 104. In some embodiments, the network 104 includes a wide area network (WAN) (i.e., the internet), a wireless WAN (WWAN) (i.e., a cellular network), a local area network (LAN), and/or the like. To manage the writing and storing of data 106 in the databases 104 and to perform other functionality, the servers 102 implement different software applications 110. Software applications 110 are provided as computer executable instructions 112 that are implemented on one or more processors 114 in each of the servers 102. The computer executable instructions 112 are stored on non-transitory computer readable medium 116 within each of the servers 102. In some embodiments, non-transitory computer-readable media 108, 116 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In FIG. 1, the data storage system 100 includes more than one of the servers 102 and more than one of the databases 104. Also, in FIG. 1, each of the servers 102 is configured to manage more than one of the databases 104. In other embodiments, the data storage system 100 includes a single server 102 and a single database 104. In still other embodiments, the data storage system 100 includes multiple servers 102 that manage a single database 104. In still other embodiments, multiple servers 102 are configured to manage the same subset of databases 104. These and other configurations for the data storage system 100 are within the scope of this disclosure.

Each of the servers 102 include a controller 118 that controls the processor frequency of the processors 114 in the servers 102. More specifically, each of the processors 114 operates in accordance with a processor clock signal. Generally, the processor clock signal includes a periodic series of pulses that are synchronized by an internal oscillator. The processor frequency is a frequency of the pulses in the clock signal. The processors 114 perform processor operations as timed by the processor clock signal and thus the higher the processor frequency, the faster the processors 114 operate. However, the higher the processor frequency, the more power is consumed by the processors 114.

The data storage system 100 thus includes a power control device 120. Power control device 120 is configured to manage power consumption by the servers 102. More specifically, power control device 120 is configured to communicate with the controllers 118 in order to adjust the processor frequencies and thus control power consumption by the servers 102. For example, amount of processor operations needed by the software applications 110 can vary depending on the time of day. Furthermore, some of the software applications 110 require a higher amount of processor operations than other software applications 110. The power control device 120 implements power control software 122 that is configured to adjust the processor frequencies of the processors 114 using the controllers 118.

The power control software 122 adjusts the processor frequencies in accordance with the varying power consumption demands of each of the software applications 110 in the servers 102. For example, in some embodiments, data storage system 100 is used by the employees of a corporate office. During worktime hours of a workday, the software applications 110 consume a higher number of processor operations of the processors 114 than during non-work hours of a workday or during weekends. Additionally, as employees are scheduled during to perform different types of tasks during the week, different days of the week often require the software applications 110 to consume a different number of processor operations than other days of the week. As another example, if the data processing system 100 is used in a consumer shopping area, a higher number of electronic transactions occur during the weekend than on workdays during work hours. The power control software 122 is configured to adjust the processing frequencies of the processors in accordance with the processing demands needed at different times and therefore consume less power than if the processor frequencies were always set as high as possible.

The power control device 120 implements the power control software 122 as computer executable instructions 124 executed on one or more processors 126. The computer executable instructions 124 are stored on a non-transitory computer readable medium 128. In some embodiments, non-transitory computer-readable media 128 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer device.

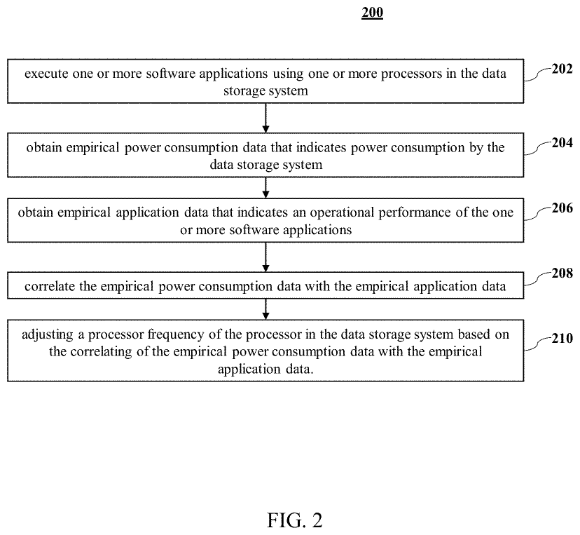

FIG. 2 is a flow diagram 200 of an exemplary method of controlling power consumption in a data storage system.

For example, the method discussed in the flow diagram 200 is implemented by the power control software 122 in power control device 120 on the data storage system 100. Flow begins at block 202.

At block 202, one or more software applications are executed using one or more processors. Examples of software applications include software applications 110 in FIG. 1 that are executed using processor(s) 114 in FIG. 1. In some embodiments, each of these software applications 110 require the implementation of different types of software modules, subprograms, software actions, software instructions, calculations, algorithms, etc. Furthermore, in some embodiments, the amount of processing power demanded by each of the different types of software modules, subprograms, software actions, software instructions, calculations, algorithms are more often used at certain time intervals and in different scenarios. Ideally, the processing frequency of processors 114 is set precisely just high enough so that processors complete all of the task within a given time interval and no higher. Flow then proceeds to block 204.

At block 204, empirical power consumption data that indicates power consumption by the data storage system is obtained. Empirical power consumption data is any data that indicates the amount of power being consumed by the data storage system that is obtained empirically. Examples of power consumption data include input power supply levels, processor power, idle time, wait time, board power levels, air system power levels, and/or the like. In some embodiments, empirical power consumption datums are measured at various temporal locations so that the variation in power consumption can be determined at different times. Flow then proceeds to block 206.

At block 206, empirical application event data that indicates the operation performance of the one or more software applications is obtained. Empirical application event data is any type of data that indicates the operations and/or operational levels of the software applications and that the application data is obtained empirically. In some embodiments, the empirical application event data is are application key performance indicators (KPIs) that are measured to indicate the activity being taken by the software applications 110. In some embodiments, empirical application datums are measured at various temporal locations so that the variation in application activity can be determined at different times. Flow then proceeds to block 208.

At block 208, the empirical power consumption data is correlated with the empirical application event data. In this manner, operations and/or operational levels of the software applications 110 are correlated with the power consumption of the data storage system 100. This correlations allow for the power control software 122 to determine how much power the data storage system 100 needs in order to appropriately perform the operations of the software application 110. Flow then proceeds to block 210.

At block 210, at least one processor frequency of the one or more processors in the data storage system is adjusted based on the correlating of the empirical power consumption data with the empirical application event data. In some embodiments, an artificial intelligence (AI) module is trained to predict what one or more processor frequency should be set to given the correlations between the application KPIs and the baremetal power telemetry data. In some embodiments, the AI module predicts future application KPIs and the resulting future baremetal power telemetry data given the future application KPIs. In this manner, the AI module is configured to output one or more future processor frequencies that provide the necessary computational processing power for the one or more processors (e.g., the processors 114) to implement the software applications (e.g., software applications 110) while the processors consume a minimum amount of power. In some embodiments, the AI module is configured to generate commands that are sent to the controllers 118 in order to adjust one or more of processor frequencies.

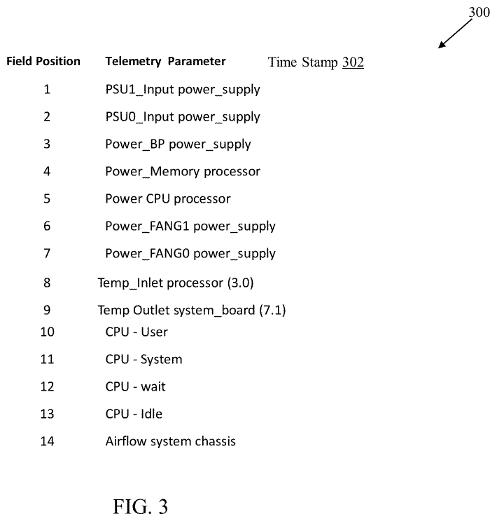

FIG. 3 illustrates one example of a power consumption datum 300, in accordance with some embodiments.

As shown, the power consumption datum 300 includes a time stamp 302 that indicates a temporal location during which the power consumption datum 300 is measured. The power consumption datum 300 also includes various fields that are indicative of power consumption by the data storage system 100. In FIG. 3, the power consumption datum 300 includes a data field PSU1_Input power_supply that records a power level value of a power supply in one of the servers 102. The power consumption datum 300 includes a data field PSU0_Input power_supply that records a power level value of another power supply in one of the servers 102 at the temporal location. The power consumption datum 300 includes a data field Power_BP power_supply that records a power level value of yet another power supply in one of the servers 102 at the temporal location. The power consumption datum 300 includes a data field Power_Memory processor that records a power level value of the power consumed by a memory processor. The power consumption datum 300 includes a data field Power_CPU processor that records a power level value of the power consumed by a processor in the central processing unit (CPU). The power consumption datum 300 includes a data field Power_FANG1 power_supply that records a power level value of the power consumed by power supply for a fan. The power consumption datum 300 includes a data field Power_FANG0 power_supply that records a power level value of the power consumed by power supply for another fan. The power consumption datum 300 includes a data field Temp_inlet processor (3.0) that records a power level value of the power consumed by an inlet processor. The power consumption datum 300 includes a data field Temp_Outlet system board (7.1) that records a power level value of the power consumed by an outlet processor on the system board. The power consumption datum 300 includes a data field CPU user that records a number of users that are utilizing the particular server 102. The power consumption datum 300 includes a data field CPU-System that records the systems being implemented by the particular server 102. The power consumption datum 300 includes a data field CPU wait that records a total wait time for the particular server 102. The power consumption datum 300 includes a data field idle a total idle time for the particular server 102. The power consumption datum 300 includes a data field Airflow chassis that records a power level value of the power consumed by a cooling system of a chassis of the particular server 102

It should be noted that the power consumption datum 300 of FIG. 3 is exemplary and not intended to be limiting. Different embodiments of the power consumption datum 300 include different types of fields depending on the particular power equipment used in a server, the particular power scheme of the server, and the parameters most relevant to power consumption in a server.

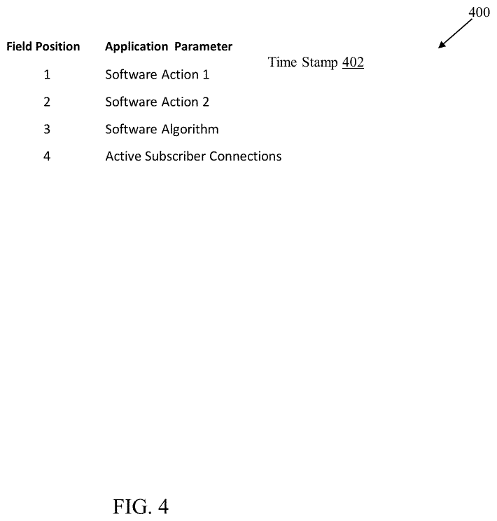

FIG. 4 illustrates one example of an application event datum 400, in accordance with some embodiments.

As shown, the application event datum 400 includes a time stamp 402 that indicates a temporal location during which the application event datum 400 is measured. The application event datum 400 also includes various fields that are indicative of operations and/or operational levels of a software application. In FIG. 3, the application event datum 400 includes a data field Software Action 1 that records a software action being taken by one of the software applications 110 at the temporal location. The application event datum 400 includes a data field Software Action 2 that records another software action being taken by the particular software applications 110. The application event datum 400 includes a data field Software Algorithm that identifies a software algorithm being implemented by the software application 110 at the temporal location.

It should be noted that the application event datum 400 of FIG. 4 is exemplary and not intended to be limiting. Different embodiments of the application event datum 400 include different types of fields depending on the particular software application being implemented by a server, the particular power scheme of the server, and the parameters most relevant to power consumption in a server.

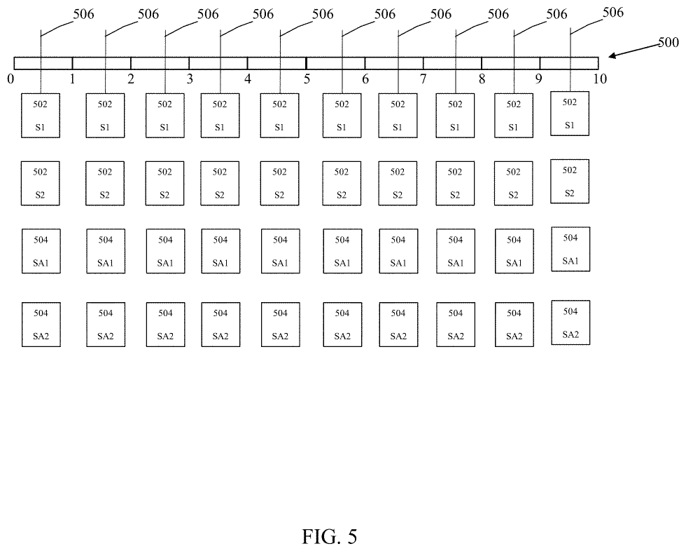

FIG. 5 is a time line 500 that illustrates the generation of different power consumption datums 502 and application event datums 504 during a time period, in accordance with some embodiments.

In some embodiments, each of the power consumptions datums 502 is formatted in a similar manner to the power consumption datum 300 in FIG. 3. However, each of the power consumption datums 502 is measured at a different temporal location 506 and includes different values in the fields, which were measured at the particular temporal location 506.

In some embodiments, each of the application event datums 504 is formatted in a similar manner to the power consumption datum 300 in FIG. 3. However, each of the application event datums 504 is measured at the different temporal location 506 and includes different values in the fields, which were measured at the particular temporal location 506.

As shown in FIG. 5, each of the power consumptions datums 502 correspond to different servers S1, S2. In some embodiments, S1 and S2 correspond to different ones of the servers 102 in FIG. 1. Each of the application event datums 504 correspond to different software applications, SA1, SA2. In some embodiment, SA1 and SA2 correspond to different ones of the software applications 110 in FIG. 1.

In FIG. 5, the time period is from 0 to 10 minutes. The time period has been divided into one minute time intervals 0 to 1 minutes, 1 to 2 minutes, 2 to 3 minutes, 3 to 4 minutes, 4 to 5 minutes, 5 to 6 minutes, 6 to 7 minutes, 7 to 8 minutes, 8 to 9 minutes, and 9 to 10 minutes. Each of these time intervals includes one of the temporal locations 506 for generating one of the power consumption datums 502 and one of the application event datums 504.

FIG. 5 thus visually illustrates one example of block 202 and block 204 in FIG. 2. In some embodiments, the power control software 122 obtains empirical power consumption datums 502 that indicate power consumption of the data storage system 100 at the different temporal locations 506. In some embodiments, the power control software 122 obtains empirical application event datums 504 that indicate the operational performance of the software applications SA1, SA2 of the data storage system 100 at the different temporal locations 506.

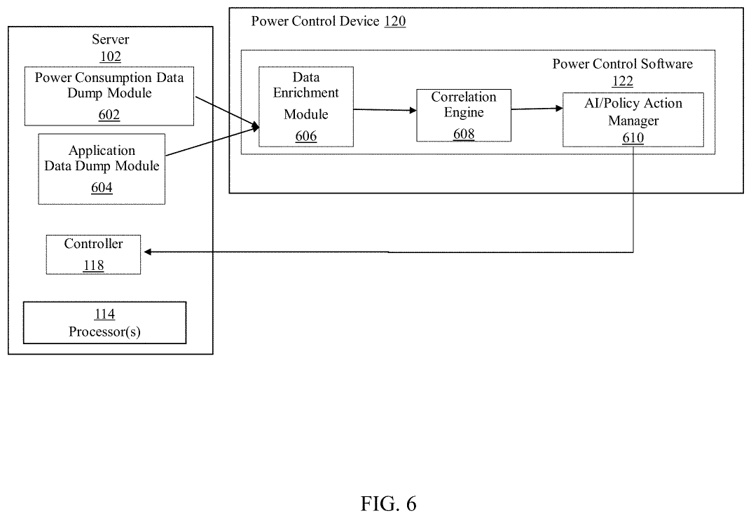

FIG. 6 is a block diagram of data storage system 600 having the server 102 and the power control device 120 along with software modules that are implemented by the server 102 and the power control device 120 in one example of a power consumption scheme.

The server 102 is configured to implement a power consumption data dump module 602 and an application data dump module 604. In some embodiments, the power consumption data dump module 602 is a collectD module. A collectD module is a daemon which collects system metrics periodically and provides mechanisms and provides algorithms to store the values. The power consumption data dump module 602 gathers a variety of power consumption data fields from the server 102 and transmits them to the power control software 122 in the power control device 120.

Additionally, the application data dump module 604 is configured to gather a variety of application data fields and transmit the application data fields to the power control software 122 in the power control device 120. In some embodiments, the application data dump module 604 is provided by an observability framework (OBF). The OBF utilizes a cloud-based infrastructure for monitoring application data fields, which include application KPIs.

In FIG. 6, the power control software 120 includes a data enrichment module 606, a correlation engine 608, and an AI/Policy action manager 610. The data enrichment module 606 is configured to organize the power consumption data fields into power consumption datums, such as the power consumption datum 300 in FIG. 3 and the power consumption datums 504 in FIG. 5. The data enrichment module 606 is also configured to organize the application event datums, such as application event datum 400 in FIG. 4 and application event datums 502 in FIG. 5.

Data enrichment module 606 is configured to transmit the application event datums and the power consumption datums to the correlation engine 608. The correlation engine 608 is configured to correlate the application event datums with the power consumption datums. In this manner, relationships are determined between the operations of the applications and the power parameters of the server 102. In some embodiments, the power parameters are associated into are correlated with different values of the processor frequencies of the processors 114 by the correlation engine 608. In some embodiments, these correlations are stored as data structures describing the correlations. The correlations between the application event datums, power consumption datums, and values of the processor frequencies are then passed to an AI/Policy Action Manager.

In some embodiments, the AI in the AI/Policy Manager is trained offline based on power consumption datums and application event datums stored from the past. Accordingly, the artificial intelligence module is trained with the correlating of the empirical power consumption datums at the different past temporal locations and with the empirical application event datums at the different past time locations. In this manner, the AI develops models that are able to predict the optimum processor frequency value with the lowest power consumption in a future time slot. The optimum processor frequency value allows for the operations of the software applications (i.e., software applications 110 in FIG. 1) at the lowest possible level of power consumption. However, the power consumption data dump module 602, the application data dump module 604, the power control software 122, and the controller 118 are configured to provide a closed loop control system. Nevertheless, the AI model cannot predict every anomaly in the behavior of the server 102. For example, the AI model cannot predict every spike in processor utilization that can trigger a closed loop action. Furthermore, any delay in the response of the closed loop system results in the loss of calibration and in turn can ruin the performance the server 102, in some embodiments. As a result, power consumption datums and application event datums are also provided in real time. Accordingly, the AI develops models that are able to predict the optimum processor frequency value with the lowest power consumption in a future time slot based on both the correlations of past power consumption datums, past application event datums, real time power consumption datums and real time application event datums.

Once the AI predicts the optimum processor frequency, the Policy Action Manager selects the type of action to be taken as a result. In some embodiments, the Policy Action Manager determines whether the optimum processor frequency is above certain thresholds for the software applications. If so, the Policy Action Manager sends a command to the controller 118 to adjust the processor frequency to the optimum processor frequency. If not, the Policy Action Manager sends a command to the controller 118 to adjust the processor frequency to a processor frequency closest to the optimum processor frequency while still being above the thresholds for the software applications. In some embodiments, AI/Policy Action Manager receive feedback regarding the performance of the software applications to determine whether the applications are actually operating as required. In some embodiments, the Policy Action Manager sends commands to the controller 118 to adjust the operating frequency of the processors 114 when feedback from the software applications indicates an unacceptable drop in performance.

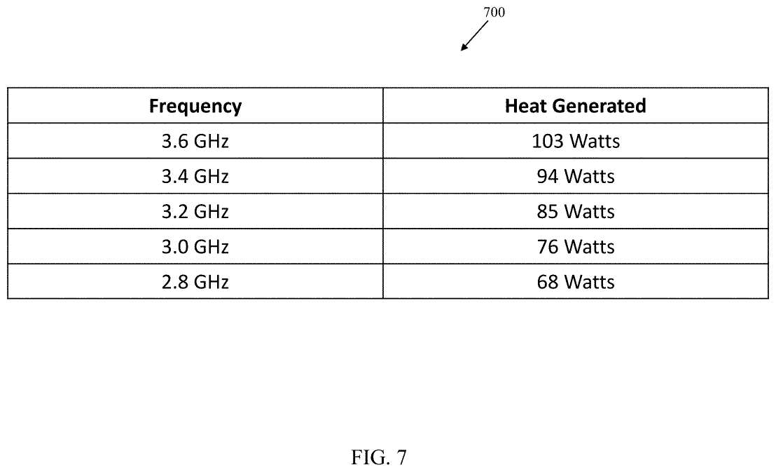

FIG. 7 is a chart 700 that indicates the relationship between a power consumption parameter and computer frequency.

In FIG. 7, each processor frequency value is associated with a heat generation amount. The processor frequency of 3.6 GHz is associated with heat generation amount of 103 Watts. The processor frequency of 3.4 GHz is associated with heat generation amount of 94 Watts. The processor frequency of 3.26 GHz is associated with a heat generation amount of 85 Watts. The processor frequency of 3.0 GHz is associated with a heat generation amount of 76 Watts. The processor frequency of 2.8 GHz is associated with a heat generation amount of 68 Watts.

In some embodiments, the correlation engine 608 (See FIG. 6) is configured to correlate the power consumption datums with the processor frequencies. As mentioned above, the correlation engine 608 is also configured to correlate the power consumption datums and the application event datums. As a result, the processor frequencies are correlated with the application event datums. In this manner, application operations are correlated with the processor frequencies. The AI/Policy Manager 610 is then configured to predict an optimum processor frequency for a future time period. The AI/Policy Manger 610 then sends commands to the controller 118 to adjust the processor frequency to the optimum processor frequency.

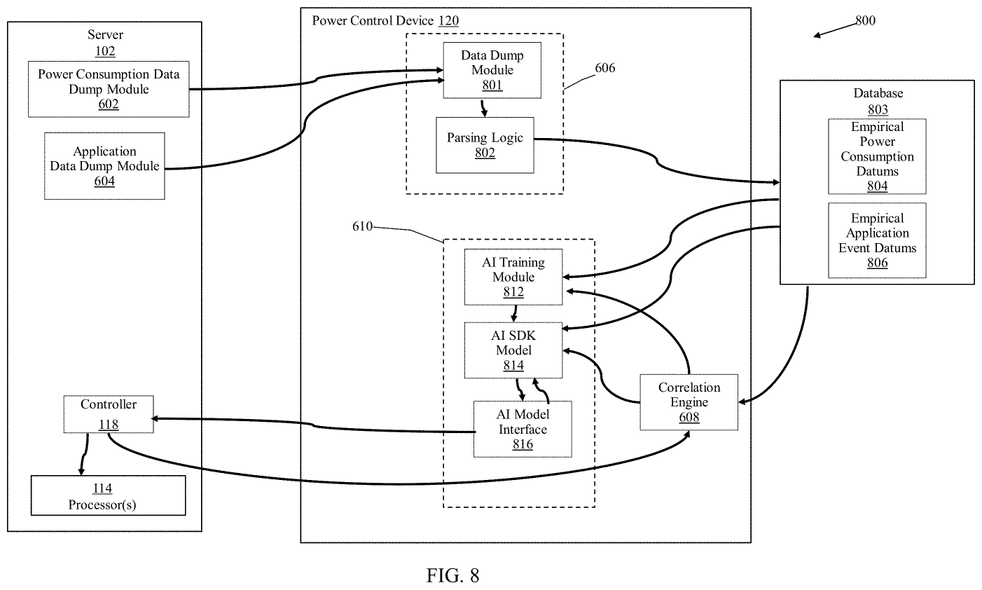

FIG. 8 is a block diagram of a data storage system 800 having the server 102 and the power control device 120 along with software modules that are implemented by the server 102 and the power control device 120 in one example of a power consumption scheme.

The server 102 includes the power consumption module 602 and the application data dump module 604, which were explained above with respect to FIG. 6. In some embodiments, the power consumption module 602 and the application data dump module 604 are implemented using a distributed event streaming platform, such as Apache Kafka®.

Both the power consumption data dump module 602 and the application data dump module 604 send power consumption fields and application data fields to the data enrichment module 606. In FIG. 8, the data enrichment module 606 includes a data dump module 801 and parsing logic 802 in the data enrichment module 606. The data dump module 801 is configured to receive the power consumption fields and application data fields to the data dump module 801. The data dump module 801 then generates a computer readable record with the power consumption fields and application data fields in a known format and provides a time stamp for the computer readable record. The data dump module 801 is then configured to transmit these computer readable records to the parsing logic 802. The parsing logic 802 is configured to generate the empirical power consumption datums 804 and the empirical application event datums 806 from the computer readable records. In some embodiments, the power consumption datums 804 are similar to the power consumption datum 300 in FIG. 3 and the power consumption datums 504 in FIG. 5. In some embodiments, the application event datums 806 are similar to the application event datum 400 in FIG. 4 and application event datums 502 in FIG. 5. The parsing logic 802 then sends the empirical power consumption datums 804 and the empirical application event datums 806 to a database 803 for storage in a non-transitory computer readable medium.

The correlation engine 608 is configured to receive the empirical power consumption datums 804 and the empirical application event datums 806. The correlation engine 608 then correlates the empirical power consumption datums 804 and the empirical application event datums 806. The correlation engine 608 also correlates the empirical power consumption datums 804 with processor frequency values shown in FIG. 7. In some embodiments, the correlation engine 608 is configured to send a command to the controller 118 directly to request a step up or a step down in the processor frequency.

The correlation engine 608 sends these correlations to the AI/Policy Action Manager 610. In FIG. 8, the AI/Policy Action Manager 610 includes an AI training module 812, an AI software development kit (SDK) model 814, and an AI Model Interface 816. The AI training module 812 is configured to operate with the AI SDK model 814 in order to train the AI SDK model 814. The AI training module 812 receives the empirical power consumption datums 804 and the empirical application event datums 806 captured as historical data from past time slots. The correlation engine 608 feeds correlations of the empirical power consumption datums 804 and the empirical application event datums 806 captured as historical data from past time slots to the AI training module 812. The AI Model Training Module 812 feeds the empirical power consumption datums 804, the empirical application event datums 806, and the correlations to learn how these are associated with the processor frequency values that allow for application operations to take place at a power level with a minimum amount of power consumption. The AI SDK model 814 develops a model that is configured to predict power consumption datums in future time slots given the operations of the software application 110 (see FIG. 1). The AI model interface 816 is then configured to receive the predicted power consumption datum and select an optimum processor frequency for the future time slot based on the predicted power consumption datum.

In some embodiments, AI Model Training Module 812 takes the history datums and constructs the AI SDK model 814. AI SDK model 814 behaviour changes as the data it receives changes. AI Model Training Module 812 continues to train the AI SDK model 814 based on latest history data and keeps feeding new data to the AI SDK model 814 either in real time or periodically (e.g. daily, weekly), to make sure AI SDK model 814 behaves as per actual scenarios which might change over time. In one limiting example, during winter seasons, many employees start office late in the morning and accordingly the user mobile traffic remains closer to residential areas until later in the morning. The AI SDK model 814 makes prediction that also will vary in accordance with this behavior.

The empirical power consumption datums 804, the empirical application event datums 806, and the correlations are also received by the AI SDK Model 814 in real-time and therefore in time-slots during operation. The AI SDK Model 814 is configured to predict a power consumption datum based on the empirical power consumption datums 804, the empirical application event datums 806 along with the training already received from the historical empirical power consumption datums 804 and the historical empirical application event datums 806. The AI SDK model 814 outputs the predicted power consumption datum for a future time slot to the AI Model Interface 816. The AI Interface 816 is then configured to select the optimum power frequency based on the predicted power consumption datum and transmit commands to the controller to adjust the processor frequency to the optimum processor frequency during the future time slot.

The AI Model Interface 816 also operates as a policy manager and determines whether the optimum processor frequency meet certain thresholds for the software application 110.

If so, the AI Model Interface 816 transmits a command to the controller 118 that request that the processor frequency of the processor(s) 114 be changed to the optimum processor frequency. If the optimum power frequency for the future time slot does not meet the thresholds, the AI Model Interface 816 transmits a command to the controller 118 that request that the processor frequency of the processor(s) 114 be changed to the an processor frequency closest to the optimum processor frequency that still maintains the thresholds.

In some embodiments, these threshold define an acceptable level of an particular KPI for a given software application. For example, if vRAN application is being is being used by users in at a particular site, the latency for vRAN processing is around 4 ms. In this case, the threshold is set to 6 ms. Thus, if latency for vRAN processing increases beyond 6 ms, the increase in latency is alarming as this reflects a significant drop in performance and thus the processor frequency should be changed.

In another non-limiting example, another threshold defines a number of user connection to the site rate. If the number of user connections to site rate drops to a defined threshold (for example: drop rate threshold is 90%), this means the number of user connections or attach rate is less than 90%. In some embodiments, this is alarming and shows a degradation in performance by the vRAN application.

In another non-limiting example, a threshold defines a maximum amount of time for an API response for a web server application. If the API response takes more time than its defined threshold, then this indicates an alarming degradation in performance. For example, if the threshold defined for API response is 10 ms, and the API response takes longer than 10 ms, then the processor frequency should be changed to improve performance.

Thresholds vary for each KPI and vary for the different types of software applications,

In this embodiment, the controller 118 also transmits application data datums to the correlation engine 608 in real-time. The correlation engine 608 correlates these application data datums with the power consumption datums 804. The AI SDK Model 813 then updates the predicted power consumption datum for the future time slot based on the real-time application data datums from the controller 118. That way, if there is unexpected application behavior, the AI SDK Model 814 can adjust in real time.

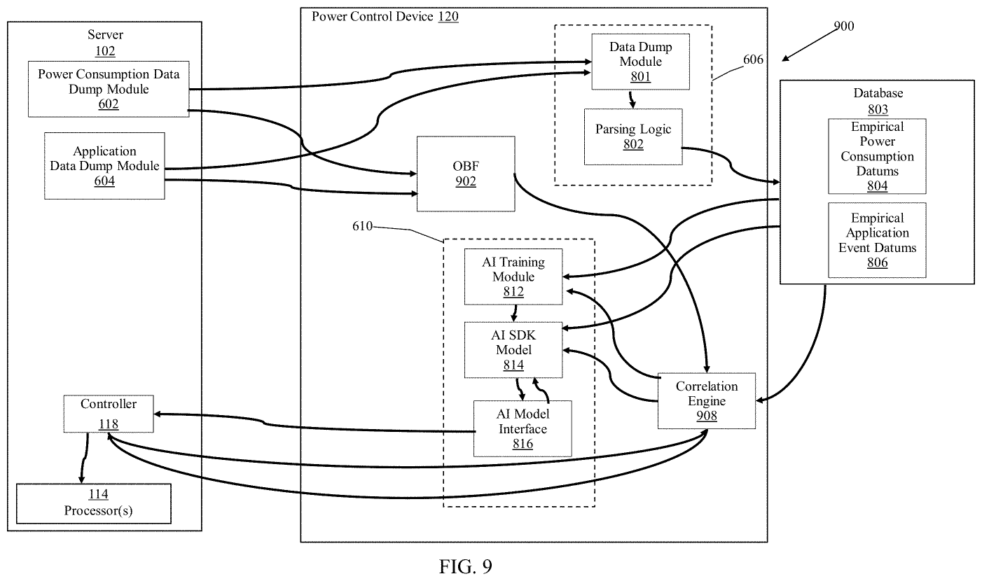

FIG. 9 is a block diagram of a data storage system 900 having the server 102 and the power control device 120 along with software modules that are implemented by the server 102 and the power control device 120 in one example of a power consumption scheme.

The power consumption data dump module 602, the application data dump module 604, the data enrichment module 606, and the AI/Policy Action Manager 610 are similar in FIG. 8 and in FIG. 9. However, this embodiment has an observability framework (OBF) 902 and a correlation engine 908.

In a first mode, the power consumption data dump module 602, the application data dump module 604, the data enrichment module 606, the AI/Policy Action Manager 610, and the correlation engine 908 operate in the same manner as the power consumption data dump module 602, the application data dump module 604, the data enrichment module 606, the AI/Policy Action Manager 610, and the correlation engine 608 described above with respect to FIG. 8.

However, in a second mode, the AI/Policy Action Manager 610 is turned off and the correlation engine 908 is configured to select an optimum processor frequency for a future time slot. Furthermore, the power consumption data dump module 602 and the application data dump module 604 sends power consumption data fields and application data fields to the OBF 602. The OBF 602 is configured to organize the power consumption data fields into empirical power consumption datums, similar to empirical power consumption datums 804, and organize the application data fields in empirical application event datums, similar to empiricial application event datums 806. The correlation engine 908 is configured to receive the empirical power consumption datums and the empirical application event datums from the OBF 602. The correlation engine 908 then correlates the empirical power consumption datums 804 and the empirical application event datums 806. The correlation engine 608 also correlates the empirical power consumption datums 804 with the operational frequencies of the processor 114. In the second mode, the correlation engine 908 is configured to output an optimum an optimum processor frequency that minimizes the amount of power consumed while being able to complete the operations of the software applications 110 (See FIG. 1) while maintaining the processor frequency above certain threshold for the software applications 110. The correlation engine 908 transmits a command to the controller 118 that request that the processor frequency of the processor(s) 114 be changed to the optimum processor frequency. The correlation engine 908 also sends commands to change the processor frequency to the optimum processor frequency.

If the performance of the software applications 110 is not above certain thresholds, the correlation engine 908 is configured to step up the processor frequency until the performance of the software application 110 is above the thresholds. If the performance of the software applications 110 is above certain thresholds, the correlation engine 908 is configured to step down the processor frequency to save power. In this manner, the correlation engine 908 ensures that the optimum processor frequency is selected in real time.

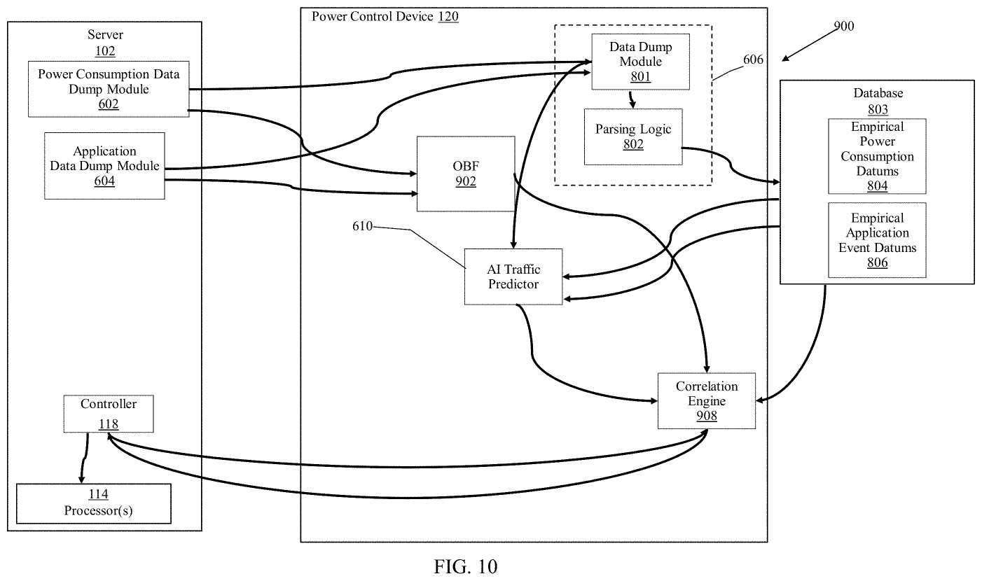

FIG. 10 is a block diagram of a data storage system 900 having the server 102 and the power control device 120 along with software modules that are implemented by the server 102 and the power control device 120 in one example of a power consumption scheme.

In FIG. 10, the power consumption data dump module 602 and the application data dump module 604 sends power consumption data fields and application data fields to the OBF 602. The OBF 602 is configured to organize the power consumption data fields into empirical power consumption datums, similar to empirical power consumption datums 804, and organize the application data fields in empirical application event datums, similar to empiricial application event datums 806. The correlation engine 908 is configured to receive the empirical power consumption datums and the empirical application event datums from the OBF 602. Furthermore, the AI/Policy Action Manager 610 operates as an AI Traffic predictor and is configured to generate future power consumption data datums and future application data datums in future time slots. The future power consumption datums predict power consumption in future time slots and the future application data datums predict application behavior in future time slots. The correlation engine 908 then correlates the empirical power consumption datums 804, the empirical application event datums 806, future power consumption datums, and future application data datums. The correlation engine 608 also correlates the empirical power consumption datums 804 and future power consumption datums with the operational frequencies of the processor 114. The correlation engine 908 is configured to output an optimum an optimum processor frequency that minimizes the amount of power consumed while being able to complete the operations of the software applications 110 (See FIG. 1) while maintaining the processor frequency above certain threshold for the software applications 110. The correlation engine 908 transmits a command to the controller 118 that request that the processor frequency of the processor(s) 114 be changed to the optimum processor frequency. The correlation engine 908 also sends commands to change the processor frequency to the optimum processor frequency.

If the performance of the software applications 110 is not above certain thresholds, the correlation engine 908 is configured to step up the processor frequency until the performance of the software application 110 is above the thresholds. If the performance of the software applications 110 is above certain thresholds, the correlation engine 908 is configured to step down the processor frequency to save power. In this manner, the correlation engine 908 ensures that the optimum processor frequency is selected in real time.

In some embodiments, a method of controlling power consumption in a data storage system, includes: executing one or more software applications using one or more processors in the data storage system; obtaining empirical power consumption data that indicates power consumption by the data storage system; obtaining empirical application event data that indicates an operational performance of the one or more software applications; correlating the empirical power consumption data with the empirical application event data; adjusting at least one processor frequency of the one or more processors in the data storage system based on the correlating of the empirical power consumption data with the empirical application event data. In some embodiments,: the obtaining the empirical power consumption data that indicates power consumption by the data storage system, includes obtaining empirical power consumption datums that indicate power consumption of the data storage system at different temporal locations; the obtaining the empirical application event data that indicates the operational performance of the one or more software applications includes obtaining empirical application event datums that indicate the operational performance of the one or more software applications of the data storage system at the different temporal locations; and the correlating the empirical power consumption data with the empirical application event data includes correlating the empirical power consumption datums at the different temporal locations with the empirical application event datums at the different time locations. In some embodiments, the adjusting the at least one processor frequency of the one or more processors in the data storage system based on the correlating of the empirical power consumption data with the empirical application event data includes: associating the empirical power consumption datums with a set of processor frequencies; selecting a processor frequency of the set of processor frequencies having a lowest power consumption that meets thresholds for the software application; and adjusting the processor frequency of the processor to the processor frequency corresponding to an optimum processor frequency. In some embodiments, the method of further includes: training an artificial intelligence module with the correlating the empirical power consumption datums at the different temporal locations with the empirical application event datums at the different time locations; implementing the artificial intelligence module to select an optimum processor frequency at one or more future temporal locations. In some embodiments, the adjusting the at least one processor frequency of the one or more processors in the data storage system based on the correlating of the empirical power consumption data with the empirical application event data includes: sending a command from the policy action manager to a controller configured to control the at least one processor frequency of the one or more processors, wherein the command indicates a frequency level of the one or more processors; setting the one or more processors to the frequency level in response to the command. In some embodiments, prior to the sending of the command from the policy action manager, the modifying the at least one processor frequency of the one or more processors in the data storage system during the future temporal locations further includes: determining whether the frequency level is above at least one threshold level of the one or more software applications, wherein the sending the command from the policy action manager to the controller is in response to determining that the frequency level is above the at least one threshold level of the one or more software applications. In some embodiments, the empirical power consumption data includes baremetal telemetry data.

In some embodiments, a computer device, includes: a first processor; a memory device configured to store computer executable instructions, the memory device being operably associated with the first processor; wherein, when the computer executable instructions are executed by the first processor, the first processor and configured to: execute a software application using second processor in the data storage system; obtain empirical power consumption data indicating power consumption by the data storage system during the executing of the software application; obtain empirical application event data indicating an operational performance of the software application; correlate the empirical power consumption data with the empirical application event data; adjust a processor frequency of the second processor in the data storage system based on the correlation of the empirical power consumption data with the empirical application event data. In some embodiments, the first processor are configured to obtain the empirical power consumption data indicating power consumption by the data storage system by obtaining empirical power consumption event datums indicating power consumption at different temporal locations of the data storage system; the first processor are configured to obtain the empirical application event data indicating the operational performance of the software application by obtaining empirical application event datums indicating the operational performance of the software application at the different temporal locations of the data storage system; and the first processor are configured to correlate the empirical power consumption data with the empirical application event data by correlating the empirical power consumption datums at the different temporal locations with corresponding empirical application event datums of the empirical application event datums at the different time locations. In some embodiments, the first processor are configured to adjust the processor frequency of the second processor by: associating the empirical power consumption datums with a set of processor frequencies; selecting a processor frequency of the set of processor frequencies having a lowest power consumption that meets thresholds for the software application; and adjusting the processor frequency of the processor to the processor frequency corresponding to an optimum processor frequency. In some embodiments, the first processor are further configured to: train an artificial intelligence module with the correlated empirical power consumption datums at the different temporal locations with the empirical application event datums at the different time locations; implement the artificial intelligence module to select an optimum processor frequency at a future temporal location. In some embodiments, the first processor are configured to adjust the processor frequency of the second processor in the data storage system based on the correlation of the empirical power consumption data with the empirical application event data by: sending a command from the policy action manager to a controller configured to control the processor frequency of the second processor, wherein the command indicates a frequency level of the second processor; setting the second processor to the frequency level in response to the command. In some embodiments, prior to the sending of the command from the policy action manager, the first processor are configured to modify the processor frequency of the second processor in the data storage system during the future temporal locations further by: determining whether the frequency level is above a threshold level of the software application, wherein the sending the command from the policy action manager to the controller is in response to a determination that the frequency level is above the threshold level of the software application. In some embodiments, the empirical power consumption data comprises baremetal telemetry data.

In some embodiments, a computer readable product, which when executed by first processor, causes the first processor to: execute a software application using the second processor in the data storage system; obtain empirical power consumption data indicating power consumption by the data storage system during the executing of the software application; obtain empirical application event data indicating an operational performance of the software application; correlate the empirical power consumption data with the empirical application event data; adjust a processor frequency of the second processor in the data storage system based on the correlation of the empirical power consumption data with the empirical application event data. In some embodiments the computer readable product causes the first processor to obtain the empirical power consumption data by obtaining empirical power consumption event datums indicating power consumption at different temporal locations of the data storage system; the computer readable product causes the first processor to obtain the empirical application event data by obtaining empirical application event datums indicating the operational performance of the software application at the different temporal locations of the data storage system; and the computer readable product causes the first processor to correlate the empirical power consumption data with the empirical application event data by correlating each of the empirical power consumption datums at the different temporal locations with corresponding empirical application event datums of the empirical application event datums at the different time locations. In some embodiments, the computer readable product causes the first processor to adjust the processor frequency of the second processor by: associating the empirical power consumption datums with a set of processor frequencies; selecting a processor frequency of the set of processor frequencies having a lowest power consumption that meets thresholds for the software application; and adjusting the processor frequency of the processor to the processor frequency corresponding to an optimum processor frequency. In some embodiments, the computer readable product further causes the first processor to: train an artificial intelligence module with the correlated empirical power consumption datums at the different temporal locations with the empirical application event datums at the different time locations; and implement the artificial intelligence module to select an optimum processor frequency at a future temporal location. In some embodiments, the computer readable product causes adjust the processor frequency of the second processor by: sending a command from a policy action manager to a controller configured to control the processor frequency of the second processor, wherein the command indicates the frequency level of the second processor; and setting the second processor to the frequency level in response to the command. In some embodiments, prior to the sending of the command, the computer readable product causes the first processor to modify the processor frequency of the second processor further by determining whether the frequency level is above a threshold level of the software application, wherein the sending the command from the policy action manager to the controller is in response to a determination that the frequency level is above a threshold level of the software application.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of controlling power consumption in a data storage system, comprising:
executing a software application using a processor in the data storage system;
obtaining empirical power consumption data indicating power consumption by the data storage system during the executing of the software application;
obtaining empirical application event data indicating an operational performance of the software application;
correlating the empirical power consumption data with the empirical application event data; and
adjusting a processor frequency of the processor in the data storage system based on the correlation of the empirical power consumption data with the empirical application event data.

2. The method of claim 1, wherein:
the obtaining the empirical power consumption data comprises obtaining empirical power consumption datums indicating power consumption of the data storage system at different temporal locations;
the obtaining the empirical application event data comprises obtaining empirical application event datums indicating the operational performance of the software application of the data storage system at the different temporal locations; and
the correlating the empirical power consumption data with the empirical application event data comprises correlating each of the empirical power consumption datums at the different temporal locations with corresponding empirical application event datums of the empirical application event datums at the different time locations.

3. The method of claim 2, wherein the adjusting the processor frequency of the processor comprises:
associating the empirical power consumption datums with a set of processor frequencies;
selecting a processor frequency of the set of processor frequencies having a lowest power consumption that meets thresholds for the software application; and
adjusting the processor frequency of the processor to the processor frequency corresponding to an optimum processor frequency.

4. The method of claim 3, further comprising:
training an artificial intelligence module with the correlated empirical power consumption datums at the different temporal locations with the empirical application event datums at the different time locations; and
implementing the artificial intelligence module to select an optimum processor frequency at a future temporal location.

5. The method of claim 1, wherein the adjusting the processor frequency of the processor comprises:
sending a command from a policy action manager to a controller configured to control the processor frequency of the processor, wherein the command indicates a frequency level of the processor; and
setting the processor to the frequency level in response to the command.

6. The method of claim 5, wherein, prior to the sending of the command, the modifying the processor frequency of the processor further comprises:
determining whether the frequency level is above a threshold level of the software application, wherein the sending the command from the policy action manager to the controller is in response to a determination that the frequency level is above the threshold level of the software application.

7. The method of claim 1, wherein the empirical power consumption data comprises baremetal telemetry data.

8. A computer device, comprising:
a first processor;
a memory device configured to store computer executable instructions, the memory device being operably associated with the first processor;
wherein, when the computer executable instructions are executed by the first processor, the first processor and configured to:
execute a software application using second processor in the data storage system;
obtain empirical power consumption data indicating power consumption by the data storage system during the executing of the software application;
obtain empirical application event data indicating an operational performance of the software application;
correlate the empirical power consumption data with the empirical application event data;
adjust a processor frequency of the second processor in the data storage system based on the correlation of the empirical power consumption data with the empirical application event data.

9. The computer device of claim 8, wherein:
the first processor are configured to obtain the empirical power consumption data indicating power consumption by the data storage system by obtaining empirical power consumption event datums indicating power consumption at different temporal locations of the data storage system;
the first processor are configured to obtain the empirical application event data indicating the operational performance of the software application by obtaining empirical application event datums indicating the operational performance of the software application at the different temporal locations of the data storage system; and
the first processor are configured to correlate the empirical power consumption data with the empirical application event data by correlating the empirical power consumption datums at the different temporal locations with corresponding empirical application event datums of the empirical application event datums at the different time locations.

10. The computer device of claim 9, wherein the first processor are configured to adjust the processor frequency of the second processor by:
associating the empirical power consumption datums with a set of processor frequencies;
selecting a processor frequency of the set of processor frequencies having a lowest power consumption that meets thresholds for the software application; and
adjusting the processor frequency of the processor to the processor frequency corresponding to the first power stat.

11. The computer device of claim 10, wherein the first processor are further configured to:
train an artificial intelligence module with the correlated empirical power consumption datums at the different temporal locations with the empirical application event datums at the different time locations;
implement the artificial intelligence module to select an optimum processor frequency at a future temporal location.

12. The computer device of claim 10, wherein the first processor are configured to adjust the processor frequency of the second processor in the data storage system based on the correlation of the empirical power consumption data with the empirical application event data by:
sending a command from the policy action manager to a controller configured to control the processor frequency of the second processor, wherein the command indicates a frequency level of the second processor;
setting the second processor to the frequency level in response to the command.

13. The computer device of claim 12, wherein, prior to the sending of the command from the policy action manager, the first processor are configured to modify the processor frequency of the second processor in the data storage system during the future temporal locations further by:
determining whether the frequency level is above a threshold level of the software application, wherein the sending the command from the policy action manager to the controller is in response to a determination that the frequency level is above the threshold level of the software application.

14. The computer device of claim 8, wherein the empirical power consumption data comprises baremetal telemetry data.

15. A computer readable product, which when executed by first processor, causes the first processor to:
execute a software application using the second processor in the data storage system;
obtain empirical power consumption data indicating power consumption by the data storage system during the executing of the software application;
obtain empirical application event data indicating an operational performance of the software application;
correlate the empirical power consumption data with the empirical application event data;
adjust a processor frequency of the second processor in the data storage system based on the correlation of the empirical power consumption data with the empirical application event data.

16. The computer readable product of claim 15, wherein:
the computer readable product causes the first processor to obtain the empirical power consumption data by obtaining empirical power consumption event datums indicating power consumption at different temporal locations of the data storage system;
the computer readable product causes the first processor to obtain the empirical application event data by obtaining empirical application event datums indicating the operational performance of the software application at the different temporal locations of the data storage system; and
the computer readable product causes the first processor to correlate the empirical power consumption data with the empirical application event data by correlating each of the empirical power consumption datums at the different temporal locations with corresponding empirical application event datums of the empirical application event datums at the different time locations.

17. The computer device of claim 16, wherein the computer readable product causes the first processor to adjust the processor frequency of the second processor by:
associating the empirical power consumption datums with a set of processor frequencies;
selecting a processor frequency of the set of processor frequencies having a lowest power consumption that meets thresholds for the software application; and
adjusting the processor frequency of the processor to the processor frequency corresponding to the first power stat.

18. The computer device of claim 17, wherein the computer readable product further causes the first processor to:
train an artificial intelligence module with the correlated empirical power consumption datums at the different temporal locations with the empirical application event datums at the different time locations; and
implement the artificial intelligence module to select an optimum processor frequency at a future temporal location.

19. The computer device of claim 17, wherein the computer readable product causes adjust the processor frequency of the second processor by:
sending a command from a policy action manager to a controller configured to control the processor frequency of the second processor, wherein the command indicates the frequency level of the second processor; and
setting the second processor to the frequency level in response to the command.

20. The computer device of claim 19, wherein, prior to the sending of the command, the computer readable product causes the first processor to modify the processor frequency of the second processor further by:
determining whether the frequency level is above a threshold level of the software application, wherein the sending the command from the policy action manager to the controller is in response to a determination that the frequency level is above the at least one threshold level of the software application.
